(19) United States
(12) Patent Application Publication
(10) Pub. No.: US 2010/0038987 A1
(43) Pub. Date: Feb. 18, 2010

(54) Motors Having a Hyperbolic Cosine Curve Shape

(75) Inventor: Chong Kyu Kim, Fort Lee, NJ (US)

Correspondence Address: SHELDON MAK ROSE & ANDERSON PC, 100 Corson Street, Third Floor, PASADENA, CA, 91103-3842, US

(73) Assignee: INFINITE WIND ENERGY LLC, Ridgefield, NJ (US)

(21) Appl. No.: 12/191,917

(22) Filed: Aug. 14, 2008

(51) Int. Cl. H02K 1/06; H02K 15/02

(52) U.S. Cl. 310/179; 29/596

(57) ABSTRACT

A motor having a hyperbolic cosine curve shaped rotor and a matching hyperbolic cosine curve shaped stator.

### CROSS-REFERENCE TO RELATED APPLICATIONS

This application claims the benefit of priority from a prior U.S. patent application to Chong Kyu Kim entitled “Hyper-Surface Wind Generator,” filed on Aug. 6, 2008, Attorney Docket No. 100547-5001.

### BACKGROUND

The present invention relates to motors, in particular to a motor with a hyperbolic cosine curve shaped rotor and a matching hyperbolic cosine curve shaped stator for higher torque and better motor balance.

There are two main types of motors available currently, alternating current (AC) motors and direct current (DC) motors. AC motors are commonly referred to, and will be referred throughout this document, as induction motors.

Induction motors are widely used and are generally the preferred choice for industrial motors due to their simple, rugged construction, lack of brushes, low cost to manufacture, and the ability to control the speed of the motor. As shown in FIG. 1, a typical induction motor 100 comprises a rotor 102 (rotating part) and a stator 104 (stationary part). Unlike other motors, induction motors 100 have a rotor 102 that is not connected to an external source of voltage. The stator 104 consists of wound poles that carry the supply current that induces a rotating magnetic field in the conductor. Rotating magnetic fields in the stator 104 cause the rotor 102 to turn, and are the key to the operation of most alternating current motors. Because the rotor 102 is free to turn, it follows the rotating magnetic field in the stator 104.

To establish a rotating magnetic field in the stator 104, the number of electromagnetic pole pairs must be the same as (or a multiple of, i.e. 2, 4, 6, etc.) the number of phases in the applied voltage. The poles must be displaced from each other by an angle equal to the phase angle between the individual phases of the applied voltage. However, for these currents to be induced, the speed of the physical rotor 102 and the speed of the rotating magnetic field in the stator 104 must be different, or else the magnetic field will not be moving relative to the rotor 102 and no currents will be induced. When this occurs, the rotor 102 typically slows slightly until a current is re-induced. This difference between the speed of the rotor 102 and speed of the rotating magnetic field in the stator 104 is called slip. Slip is the ratio between the relative speed of the rotating magnetic field as seen by the rotor 102 and the speed of the rotating magnetic field produced by the stator 104. Both of the two main types of rotors currently produced, squirrel-cage rotors and slip ring rotors, have slip to various degrees. Additionally, both types of rotors suffer from low starting torque, which is the ability to move the load that is attached to the motor.

The most common rotor is a squirrel-cage rotor 200, as shown in FIG. 2. It is made up of bars of either solid copper or aluminum that span the length of the rotor, and are connected through a ring at each end, forming a cage-like shape. The core of the squirrel-cage rotor 200 is built of a stack of iron laminations. The conductors in this type of rotor, however, need to be skewed slightly along the length of the rotor to reduce noise and smooth out torque fluctuations that occur due to interactions with the pole pieces of the stator. The structure of this type of rotor also results in eddy current loss, requiring exotic materials and extra manufacturing to reduce the eddy current losses.

Induction motors must use other types of rotors in addition to the squirrel cage rotor 200. The squirrel cage rotor windings are employed to provide near-synchronous speed while the motor is starting. When a motor is operating at synchronous speed, the magnetic field is rotating at the same speed as the rotor, so no current will be induced into the squirrel cage rotor 200 windings and it will have no further effect on the operation of the induction motor.

Slip ring motors are the other main type of rotor manufactured currently. As shown in FIG. 3, a slip ring rotor 300 makes an electrical connection through a rotating assembly. Slip ring rotors require the use of these slip rings, also called rotary electrical interfaces, rotating electrical connectors, collectors, swivels or electrical rotary joints, which consist of a conductive circle or band mounted on a shaft and insulated from it. Electricity is transferred from the rotor 300 to the slip ring using fixed contacts or brushes that are in contact with the slip ring. These contacts and/or brushes wear out over time, however, and need to be replaced. In addition, as the contacts and/or brushes wear out and collect debris and grit over time, the effectiveness of the electrical transfer diminishes. Friction induced by the contacts and/or brushes contacting the rotor reduces the motor's efficiency.

DC motors operate by placing a current-carrying conductor (an armature) in a magnetic field perpendicular to the lines of flux. The conductor then moves in a direction perpendicular to the magnetic lines of flux. A DC motor rotates as a result of two magnetic fields interacting with each other.

Voltage is transmitted through the armature coils by sliding contacts or brushes that are connected to a DC voltage source. The brushes are found on the end of the coil wires and make a temporary electrical connection with the DC voltage source. For example, in a single armature DC motor, the brushes will make a connection every 180 degrees and current will then flow through the coil wires. At 0 degrees, the brushes contact the DC voltage source and current flows through the armature interacting with the magnetic field that is present, resulting in an upward force on the upper armature segment and a downward force on the lower armature segment. Both the upward force and the downward force are equal in magnitude, but in opposing directions since the direction of current flow in the segments are reversed with respect to the stationary magnetic field. At 180 degrees, the same interaction occurs, but the lower armature segment is forced up and the upper armature segment is forced down. Disadvantageously, at 90 degrees and 270 degrees, the brushes are not in contact with the DC voltage source and no force is produced. At these two positions, the rotational kinetic energy of the DC motor keeps it spinning until the brushes regain contact.

A large amount of torque ripple is also produced by DC motors because the armature coil only has a force applied to the armature at the 0 and 180 degree positions. The rest of the time the coil spins on its own and the torque drops to zero. Therefore, more armature coils are required to smooth out the torque curve. The resulting torque curve never reaches zero, and the average torque is increased as more and more coils are added. However, the increase in torque is limited when the torque curve approaches a straight line and has very little torque ripple and the motor runs much more smoothly. Another method of increasing the torque and rotational speed of the motor is to increase the current supplied to the coils. This is accomplished by increasing the voltage that is sent to the motor, thus increasing the current at the same time.

A brushed DC motor generates torque directly from DC power supplied to the motor by using internal commutation, stationary permanent magnets, and rotating electrical magnets. The advantages of a brushed DC motor include low initial cost, high reliability, and simple control of motor speed. Disadvantages include high maintenance and low life-span for high intensity uses. Maintenance involves regularly replacing the brushes and springs which carry the electric current, as well as cleaning or replacing the commutator.

### SUMMARY OF THE INVENTION

The present invention comprises an improved motor having a hyperbolic cosine curve shaped stator and a matching hyperbolic cosine curve shaped rotor electromagnetically coupled to the stator, which provides higher torque and better motor balance than prior motors. The motor can be an induction motor, a direct current motor, or a universal motor. Preferably, the motor is an induction motor and comprises slots in the hyperbolic cosine curve shape of the stator for accommodating a primary winding to generate a rotary magnetic field when electricity is applied to the primary winding. Such an induction motor can further comprise slots in the hyperbolic cosine curve shape of the rotor for a secondary winding to generate a torque by an electromagnetic induction between the secondary winding and the primary winding when electricity is applied to the primary winding.

In an induction motor according to the present invention, the rotor and the stator preferably have the same hyperbolic cosine curve shape, and this shape is preferably a catenoid. In one embodiment, the rotor of the induction motor can comprise two or more hyperbolic cosine curve shaped rotor portions, or alternatively can comprise a first half-hyperbolic cosine curve shaped rotor portion and a second half-hyperbolic cosine curve shaped rotor portion. The stator of the present induction motor can likewise comprise two or more hyperbolic cosine curve shaped stator portions, or alternatively can comprise an upper half-hyperbolic cosine shaped stator portion and a lower half-hyperbolic cosine shaped stator portion.

In one embodiment, the present induction motor has a stator that comprises a stator cage having 3 or more stator elements. The stator elements are each laminated, and each layer of lamination comprises a hyperbolic cosine curve shape. Such a stator can further comprise wire coils looped around each of the stator elements to create electromagnets. In this embodiment, the stator elements are preferably electrically 120 degrees apart from each other.

In a further embodiment, the present motor is a direct current motor. The stator of such a direct current motor preferably comprises two or more electromagnetic field poles, and the electromagnetic field poles preferably comprise coils of insulated copper wire wound on conductive cores in a hyperbolic cosine curve shape. This direct current motor can also include an armature rotor having a hyperbolic cosine curve shape.

Preferably, the rotor and the stator of a DC motor according to the present invention have the same hyperbolic cosine curve shape, which can be a catenoid. Such a direct current motor can be manufactured from a first half-hyperbolic cosine curve shaped rotor portion and a second half-hyperbolic cosine curve shaped rotor portion, or alternatively from two or more hyperbolic cosine curve shaped rotor portions. The stator can likewise comprise an upper half-hyperbolic cosine curve shaped stator portion and a lower half-hyperbolic cosine curve shaped stator portion, or alternatively can comprise two or more hyperbolic cosine curve shaped stator portions.

Another aspect of the present invention comprises methods of constructing an induction or DC motor. In one embodiment, this method can comprise the steps of:

a) providing a catenoid shaped stator having a first end and a second end;

b) providing a first half-catenoid shaped rotor portion to be inserted in the first end of the stator;

c) providing a second half-catenoid shaped rotor portion to be inserted in the second end of the stator;

d) aligning the first half-catenoid shaped rotor portion and the second half-catenoid shaped rotor portion to balance the motor; and

e) connecting the first half-catenoid shaped rotor portion and the second half-catenoid shaped rotor portion.

In another embodiment of a method for constructing an induction motor, the method includes the steps of:

a) providing a catenoid shaped rotor;

b) providing a upper half-catenoid shaped stator portion to cover the upper portion of the rotor;

c) providing a lower half-catenoid shaped stator portion to cover the lower portion of the rotor;

d) aligning the upper stator portion and the lower stator portion to balance the motor; and

e) connecting the upper stator portion to the lower stator portion enclosing the rotor.

A method of constructing a direct current motor according to the present invention can comprise the following steps:

a) providing a catenoid shaped stator having a first end and a second end;

b) providing a first half-catenoid shaped rotor portion to be inserted in the first end of the stator;

c) providing a second half-catenoid shaped rotor portion to be inserted in the second end of the stator;

d) aligning the first half-catenoid shaped rotor portion and the second half-catenoid shaped rotor portion to balance the motor; and

e) connecting the first half-catenoid shaped rotor portion and the second half-catenoid shaped rotor portion.

In a further embodiment, a direct current motor according to the present invention can be manufactured by a method having the following steps:

a) providing a catenoid shaped rotor;

b) providing a upper half-catenoid shaped stator portion to cover the upper portion of the rotor;

c) providing a lower half-catenoid shaped stator portion to cover the lower portion of the rotor;

d) aligning the upper stator portion and the lower stator portion to balance the motor; and

e) connecting the upper stator portion to the lower stator portion enclosing the rotor.

### BRIEF DESCRIPTION OF THE DRAWINGS

FIG. 1 is a perspective view of a prior art alternating current induction motor.

FIG. 2 is a perspective view of a prior art squirrel cage rotor.

FIG. 3 is a perspective view of a prior art a slip ring rotor.

FIG. 4 is a diagram of a bar magnet illustrating magnet fields around the bar magnet.

FIG. 5 is a diagram of a torus.

FIG. 6 is a graph of a torus and a hyperbolic cosine function of a catenary curve.

FIG. 7 is a diagram of a catenoid.

FIG. 8 is a perspective view of a hyperbolic cosine curve shaped stator according to one embodiment of the present invention.

FIG. 9 is a perspective view of a hyperbolic cosine curve shaped rotor according to another embodiment of the present invention.

FIG. 10 is an exploded view of a catenoid rotor according to one embodiment of the present invention.

FIG. 11 is a perspective view of a complete catenoid induction motor according to a further embodiment of the present invention.

FIG. 12A is a plan cross-sectional view of a prior art direct current motor.

FIG. 12B is a perspective cross-sectional view of the prior art direct current motor of FIG. 12A.

FIG. 13A is a plan cross-sectional view of a hyperbolic cosine curve shaped direct current motor according to another embodiment of the present invention.

FIG. 13B is a perspective cross-sectional view of the hyperbolic cosine curve shaped direct current motor of FIG. 13A.

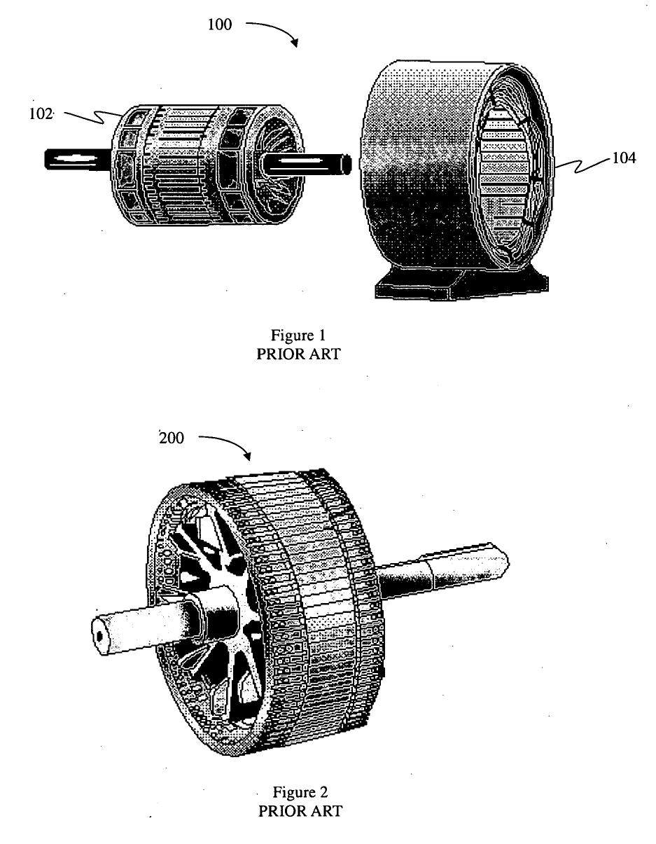

### DETAILED DESCRIPTION

In describing the features of this invention, the following terms and variations thereof are used, and such terms have the meanings given below, unless a different meaning is clearly intended by the context in which such term is used.

“Cage” refers to the short-circuiting end rings of a rotor that complete the “squirrel cage,” which rotates when a moving magnetic field induces current in the shorted conductors.

“Catenary” refers to a curve, with the Cartesian equation of y=a cosh(x/a), such as is formed by a flexible cable of uniform density hanging from two points under its own weight. For example, cables of suspension bridges and cables attached to telephone poles form this shape.

“Catenoid” refers to a three-dimensional shape made by rotating a catenary curve around an x-axis in a Cartesian coordinate plane.

“Commutation” refers to the process by which a DC voltage output is taken from an armature that has an alternating current voltage induced in it.

“Hyperbolic cosine curve shape” refers to a three-dimensional shape made by rotating a hyperbolic cosine curve around an x-axis in a Cartesian coordinate plane.

“Rotor” refers to the rotating component of a motor, generator or alternator, typically constructed of a laminated, cylindrical iron core with slots for receiving conductors, such as, for example, cast-aluminum conductors or copper conductors.

“Stator” refers to a fixed part of a motor, generator or alternator that does not rotate, typically consisting of copper windings within steel laminations.

“Torus” refers to a surface of revolution generated by revolving a circle in three dimensional space about an axis coplanar with the circle, which does not touch the circle. For example, a donut or an inner tube are each examples of a torus.

“Winding” refers to a coil or coils, typically made of copper wire, wrapped around a core, usually of steel. In an alternating current induction motor, a primary winding is the stator, typically consisting of wire coils inserted into slots within steel laminations. A secondary winding of an alternating current induction motor is typically the rotor.

“Universal motor” refers to a motor that can use either an alternating current power supply or a direct current power supply.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

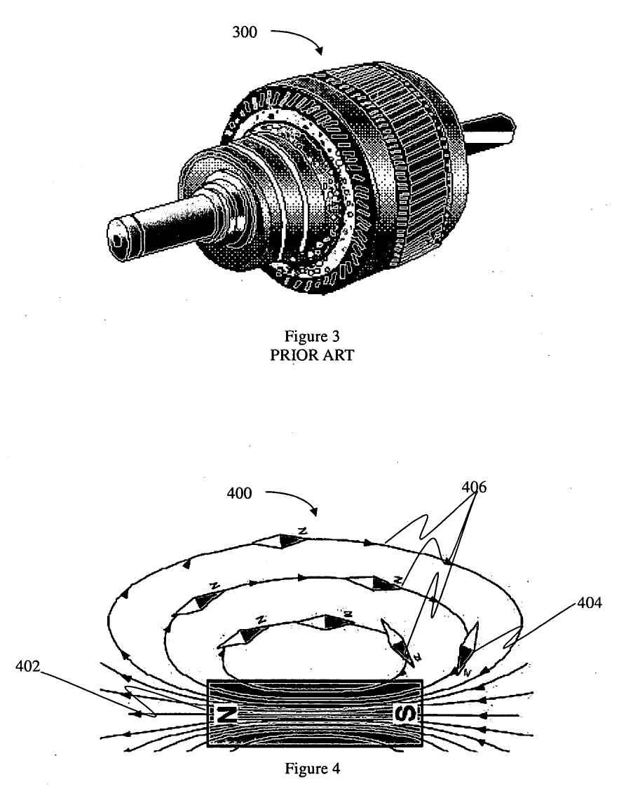

Referring now to FIG. 4, there is shown a diagram of a bar magnet 400 illustrating magnet fields 406 around the bar magnet 400. A first magnetic field point 402 is considered the strongest and straightest point on the bar magnet 400. A second magnetic field point 404 represents a curved portion of the magnetic fields 406 surrounding the bar magnet 400. The second magnetic field point 404 will have as many magnetic fields 406 as the first magnetic field point 402, because the first magnetic field point 402 and the second magnetic field point 404 are both curved magnetic fields. Current induction motors use the straightest area of the magnetic fields, the first magnetic field point 406, to produce torque for the motor. The present invention obtains energy at curved points relative to the second magnetic field point 404. Due to the inherent curve of the magnetic fields 406, the straightest point on the field is in fact a curve.

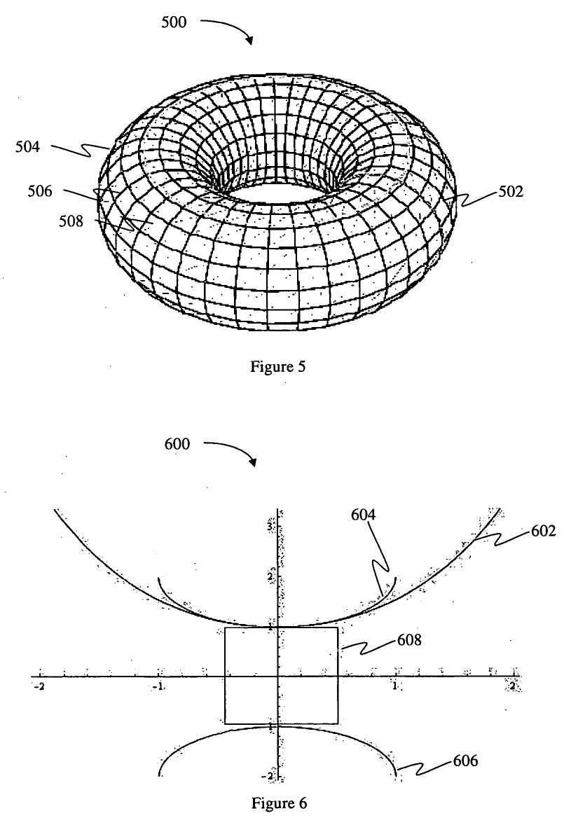

Referring now to FIG. 5, there is shown a diagram of a torus 500. The torus 500, in its fundamental form, is a circle rotated around and axis at a set distance. Standard induction motors have a stator 104 that is similar to an antenna within a cylinder. An antenna, when radiating, produces electromagnetic waves in all directions forming the torus 500. The reference to antennas is made to help conceptualize the magnetic fields used in the present invention. Radio frequency wave-guide theory suggests that the torus 500 is a larger view of an electromagnetic wave propagation motor containing a stator that is essentially a coil winding on a laminated grid disk acting as electromagnet. Each grid 504, 506, 508 of the torus 500 can be viewed as an individual electromagnet antenna in a closed cylinder and therefore every point on the induction motor is an individual electromagnet. As is known, magnetic force weakens by its distance squared, therefore it is very important to have the rotor 102 close to the stator 104. One approach to improve the function of an induction motor is to scale down the torus 500 by way of the rotor 102 to fit into the stator 104 of the induction motor.

Referring now to FIG. 6, there is shown a graph of a torus 602 and a hyperbolic cosine function of a catenary curve 604 and 606. A square 608 is graphed at the point (0.5, 0.5), (0.5, 0.5) on the Cartesian plane to better illustrated the plotted curve functions. An arc portion of the torus circle 602 can be set to match the hyperbolic cosine 604 or inverse hyperbolic cosine function. The range of the arc point is located at 0 to 0.5 of the x-axis. This mathematical function shows that the catenoid 604 can be embedded directly into the torus at the lower range. As can be seen, the arc of the hyperbolic cosine function 604 fits into a portion of the torus circle 602. The arc of the circle that is formed in the torus circle 602 is a hyperbolic cosine function, and more particularly a catenary 604. The torus 602 and the catenoid 604 are two different shapes, but share a common arc point of the circle at Cartesian coordinates 0 to 0.5 on the x axis of the graph. As can be seen, the maximum Cartesian coordinate y value of the catenary curve is 1.2, which is a 20% radial increase from the end of the square 608.

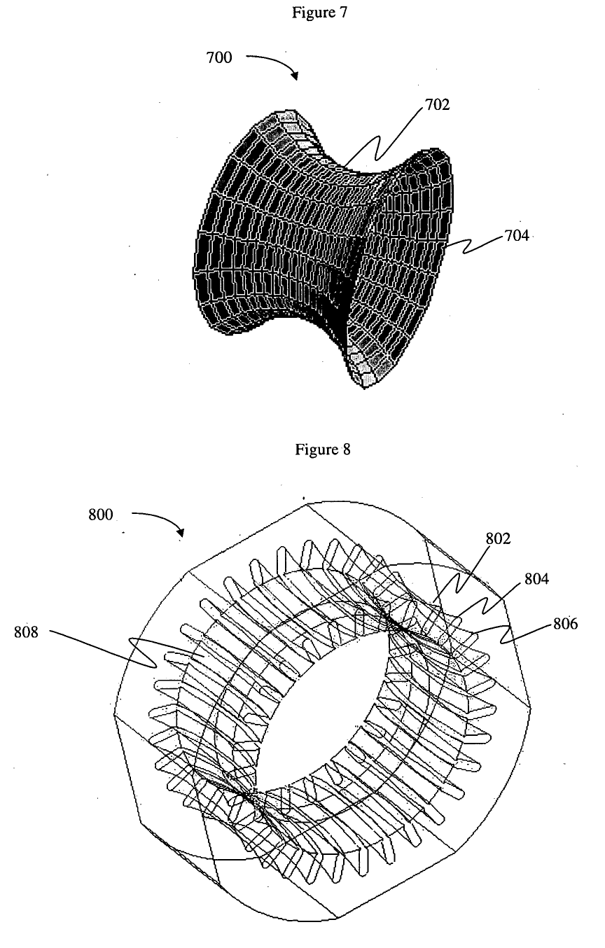

Referring now to FIG. 7, there is shown a three dimensional diagram of a catenoid 700. As is known, torque measures the tendency of a force to rotate an object about some axis and is calculated by a force times a length. There is a clear advantage for increasing torque in the catenoid 700 as the radius of the catenoid 700 increases as a function of cosh(x). The torque increase of the catenoid 700 can be computed by obtaining a new radius value for each disk contained in the catenoid 700, because the only value changing in the catenoid 700 is the distance from the axis to the hyperbolic curve. Additionally, a center of mass 702 is derived for the catenoid 700 and is approximately half the distance from the end points. An inertia mass 704 for the catenoid 700 is calculated as the sum of a circular disk at the end points of the catenoid 700. Therefore, a catenoid shaped rotor has center of mass 702 at the half point but the inertia mass is located on the hyperbolic radius 704, whereas the cylinder 102 has its center of mass at the half point and it inertia mass at the half point. Therefore, the catenoid 700 will provide better balance than the cylinder 102 because a curved wire is easier to balance than a straight wire.

Referring now to FIG. 8, there is shown a three dimensional drawing of a hyperbolic cosine curve shaped stator 800. In a preferred embodiment, the hyperbolic cosine curve shape used for stators and rotors according to the present invention is a catenoid. The catenoid shaped stator 800 comprises stator elements 802, 804, 806 that are laminated and form a catenoid shaped cage 808 with catenoid shaped curves created by the stator elements 802, 804, 806. In one embodiment, a wire coil can be looped around each stator element 802, 804, 806 to create electromagnets that are electrically 120 degrees apart, for a three phase motor.

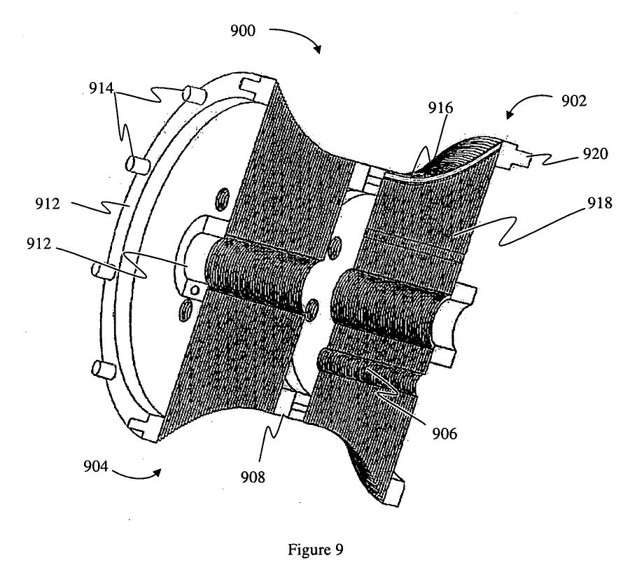

Referring now to FIG. 9, there is shown a three dimensional drawing of a hyperbolic cosine shaped rotor 900 according to one embodiment of the present invention. While hyperbolic cosine shaped rotors and stators are preferably solid, manufacturing or cost considerations may dictate that they not be entirely solid or that they be manufactured in pieces that are then joined. For example, in a preferred embodiment, two or more catenoid rotor portions 902 and 904 can be manufactured separately and joined together around the motor shaft 910 to form a complete catenoid shaped rotor 900 inside the catenoid shaped stator 800. In one embodiment, the steel rings 906 and 908 can comprise male to female connections for joining the two halves together. In another embodiment, copper end rings 914 and 916 can comprise holes where threaded rods can be placed to lock the two half catenoid rotor portions 902 and 904 together.

As discussed above, the catenoid shaped rotor 900 and the catenoid shaped stator 800 provide more torque and better balance than a traditional cylinder shaped rotor 102. Additionally, the outer radial portion 914 of the catenoid shaped rotor 900 provides more balance to the motor. Thick copper wire 916 can be placed on the surface of a laminated steel disk 918 that is curved along a hyperbolic cosine function to provide the induction between the rotating magnetic field of the catenoid shaped stator 800 and the catenoid shaped rotor 900. In one embodiment, a laminated steel disk 914 supports the thick copper wire 916 and is shorted at the end points so it will not interfere with the electromagnetic fields induced into the catenoid shaped rotor 900 by the catenoid shaped stator 800. Thicker steel rings 906 and 908 can be used to mate the two half catenoid rotor portions 902 and 904.

Referring now to FIG. 10, there is shown a perspective drawing of a fully assembled catenoid rotor according to one embodiment of the present invention. A motor shaft 1002 is placed through the center of the catenoid rotor 1000 and locked into place using collars 1004 and 1006.

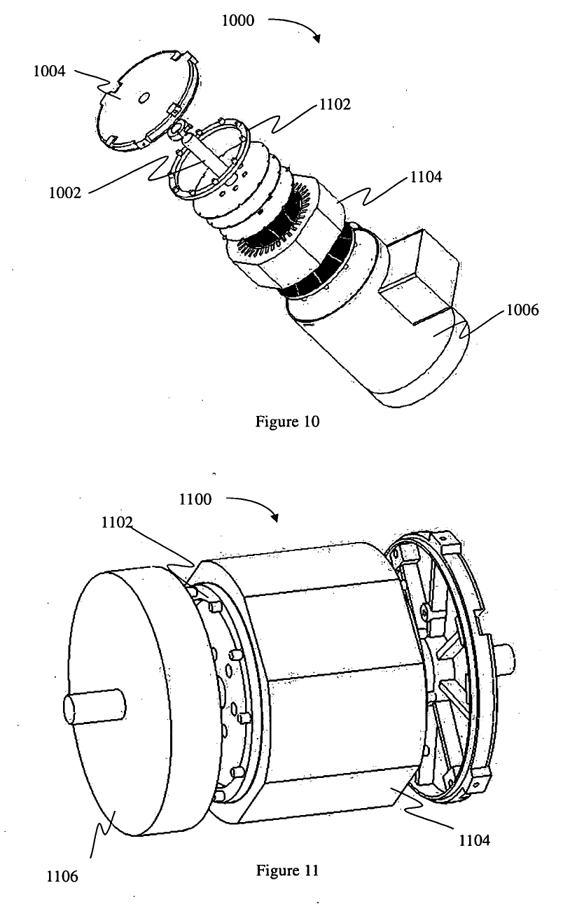

FIG. 11 shows a complete catenoid induction motor 1100 according to one embodiment of the present invention. The motor 1100 comprises the catenoid rotor 1102 that is electromagnetically connected to the stator 1104. The catenoid rotor 1102 is physically connected to a load 1106 to perform work.

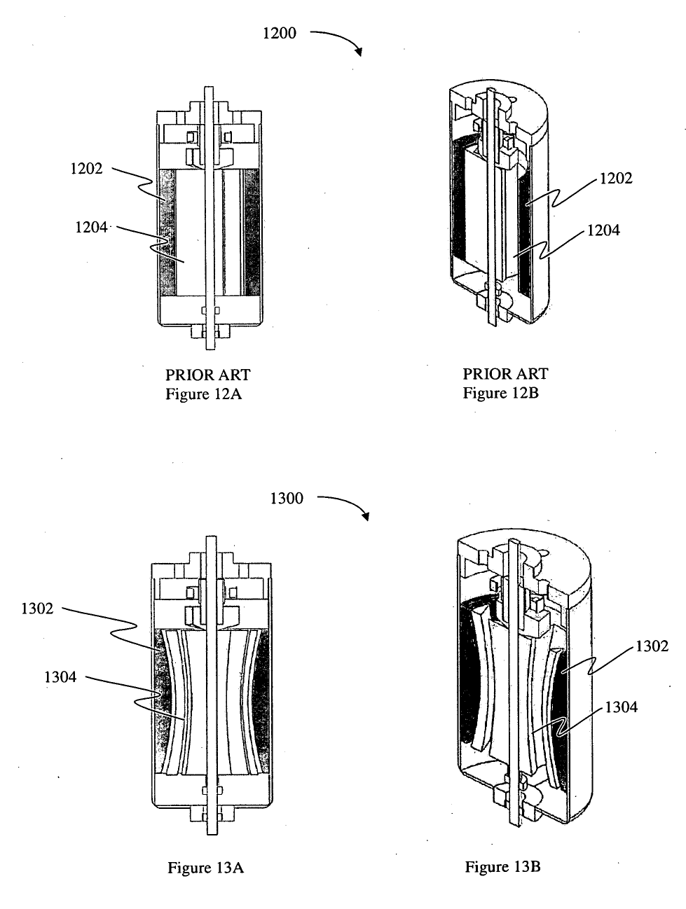

Referring now to FIG. 12, there is shown cross sectional view of a prior art direct current motor 1200. As can be seen, a typical prior art direct current motor 1200, or direct current generator depending upon the configuration of the motor, comprises a cylindrical shaped stator portion 1202 that is electromagnetically connected to a cylindrical shaped rotor portion 1204. The DC motor comprises stationary magnetic field poles and an armature that turns on bearings in the space between the field poles. The armature of a DC motor typically comprises windings connected to commutator segments.

The disadvantages of the prior art direct current motor 1200 comes from the shape of the rotor 1204 and stator 1202. The prior art direct current motor 1300 either produces movement or generates electricity by cutting electromagnetic flux lines of force. However, the cylindrical shape of the prior art direct current motor only interacts with a small portion of the electromagnetic flux lines of force, thereby reducing the efficiency.

Referring now to FIG. 13, there is shown a cross-sectional view of a hyperbolic cosine curve shaped direct current motor 1300 according to another embodiment of the present invention. The stator 1302 comprises two or more electromagnetic field poles. The two or more electromagnetic field poles can comprise coils of insulated copper wire wound on conductive cores in a hyperbolic cosine curve shape. The direct current motor 1300 also has an armature rotor 1304 having a hyperbolic cosine curve shape. In a preferred embodiment, the rotor 1304 and the stator 1302 have the same hyperbolic cosine curve shape, such that the surface of the rotor 1304 that faces the stator 1302 is the inverse of the surface of the stator 1302 that faces the rotor 1304. In a particularly preferred embodiment, the hyperbolic cosine curve shape is a catenoid.

To construct the direct current motor 1300, two portions of the rotor 1304 can be constructed separately so that the rotor 1304 comprises a first half-hyperbolic cosine shaped rotor portion and a second half-hyperbolic cosine curve shaped rotor portion. Another method to construct the direct current motor 1300 is to have the rotor comprise two or more hyperbolic cosine curve shaped rotor portions that are assembled inside the stator 1302 portion of the direct current motor 1300. Alternatively, the stator 1302 can be constructed in portions such that the stator 1302 comprises an upper half-hyperbolic cosine curve shaped stator portion and a lower half-hyperbolic cosine curve shaped stator portion that can be placed around a rotor 1304, which can be constructed in separate pieces as previously described or as a single complete unit. In a preferred embodiment, the stator 1302 comprises two or more catenoid shaped stator portions that can be constructed and assembled around the rotor 1304. Although AC and DC motors have been described herein separately, one of skill in the art will appreciate that a universal motor (having both an induction motor and a direct current motor) can comprise hyperbolic cosine curve shaped rotors and stators as described herein.

Although the present invention has been discussed in considerable detail with reference to certain preferred embodiments, other embodiments are possible. The drawings and the associated descriptions are thus provided to illustrate embodiments of the invention and not to limit the scope of the invention. The steps disclosed for the present methods are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

What is claimed is:

1. A motor comprising:
a) a stator having a hyperbolic cosine curve shape; and
b) a rotor having a hyperbolic cosine curve shape electromagnetically coupled to the stator.

2. The motor of claim 1, wherein the motor is an induction motor.

3. The induction motor of claim 2, further comprising slots in the hyperbolic cosine curve shape of the stator for accommodating a primary winding to generate a rotary magnetic field when electricity is applied to the primary winding.

4. The induction motor of claim 2, further comprising slots in the hyperbolic cosine curve shape of the rotor for a secondary winding to generate a torque by an electromagnetic induction between the secondary winding and the primary winding when electricity is applied to the primary winding.

5. The induction motor of claim 2, wherein the rotor and the stator have the same hyperbolic cosine curve shape.

6. The induction motor of claim 5, wherein the hyperbolic cosine curve shape is a catenoid.

7. The induction motor of claim 5, wherein the rotor comprises two or more hyperbolic cosine curve shaped rotor portions.

8. The induction motor of claim 5, wherein the rotor comprises a first half-hyperbolic cosine curve shaped rotor portion and a second half-hyperbolic cosine curve shaped rotor portion.

9. The induction motor of claim 5, wherein the stator comprises two or more hyperbolic cosine curve shaped stator portions.

10. The induction motor of claim 5, wherein the stator comprises an upper half-hyperbolic cosine shaped stator portion and a lower half-hyperbolic cosine shaped stator portion.

11. The induction motor of claim 2, where the stator further comprises:
a) a stator cage comprising 3 or more stator elements, wherein the stator elements are each laminated, and wherein each layer of lamination comprises a hyperbolic cosine curve shape; and
b) wire coils looped around each of the stator elements to create electromagnets.

12. The induction motor of claim 11, wherein the stator elements are electrically 120 degrees apart from each other.

13. The motor of claim 1, wherein the motor is a direct current motor.

14. The direct current motor of claim 13, wherein the stator further comprises two or more electromagnetic field poles, and wherein the two or more electromagnetic field poles comprise coils of insulated copper wire wound on conductive cores in a hyperbolic cosine curve shape.

15. The direct current motor of claim 13, further comprising an armature rotor having a hyperbolic cosine curve shape.

16. The direct current motor of claim 13, wherein the rotor and the stator have the same hyperbolic cosine curve shape.

17. The direct current motor of claim 16, wherein the hyperbolic cosine curve shape is a catenoid.

18. The direct current motor of claim 16, wherein the rotor comprises a first half-hyperbolic cosine curve shaped rotor portion and a second half-hyperbolic cosine curve shaped rotor portion.

19. The direct current motor of claim 16, wherein the rotor comprises two or more hyperbolic cosine curve shaped rotor portions.

20. The direct current motor of claim 16, wherein the stator comprises an upper half-hyperbolic cosine curve shaped stator portion and a lower half-hyperbolic cosine curve shaped stator portion.

21. The direct current motor of claim 16, wherein the stator comprises two or more hyperbolic cosine curve shaped stator portions.

22. A method of constructing an induction motor for better torque and balance comprising the steps of:
a) providing a catenoid shaped stator having a first end and a second end;
b) providing a first half-catenoid shaped rotor portion to be inserted in the first end of the stator;
c) providing a second half-catenoid shaped rotor portion to be inserted in the second end of the stator;
d) aligning the first half-catenoid shaped rotor portion and the second half-catenoid shaped rotor portion to balance the motor; and
e) connecting the first half-catenoid shaped rotor portion and the second half-catenoid shaped rotor portion.

23. A method of constructing an induction motor for better torque and balance comprising the steps of:
a) providing a catenoid shaped rotor;
b) providing a upper half-catenoid shaped stator portion to cover the upper portion of the rotor;
c) providing a lower half-catenoid shaped stator portion to cover the lower portion of the rotor;
d) aligning the upper stator portion and the lower stator portion to balance the motor; and
e) connecting the upper stator portion to the lower stator portion enclosing the rotor.

24. A method of constructing a direct current motor for better torque and balance comprising the steps of:
a) providing a catenoid shaped stator having a first end and a second end;
b) providing a first half-catenoid shaped rotor portion to be inserted in the first end of the stator;
c) providing a second half-catenoid shaped rotor portion to be inserted in the second end of the stator;
d) aligning the first half-catenoid shaped rotor portion and the second half-catenoid shaped rotor portion to balance the motor; and
e) connecting the first half-catenoid shaped rotor portion and the second half-catenoid shaped rotor portion.

25. A method of constructing a direct current motor for better torque and balance comprising the steps of:
a) providing a catenoid shaped rotor;
b) providing a upper half-catenoid shaped stator portion to cover the upper portion of the rotor;
c) providing a lower half-catenoid shaped stator portion to cover the lower portion of the rotor;
d) aligning the upper stator portion and the lower stator portion to balance the motor; and
e) connecting the upper stator portion to the lower stator portion enclosing the rotor.
